(19) United States
(12) Patent Application Publication
(10) Pub. No.: US 2026/0171582 A1
(43) Pub. Date: Jun. 18, 2026

(54) STORAGE CASE FOR BATTERIES FOR WEARABLE ELECTRONIC DEVICES

(71) Applicant: Raven Resonance, Inc., San Francisco, CA (US)

(72) Inventors: Ivan France, Saratoga, CA (US); Curtis Aumiller, San Jose, CA (US); Thomas Suarez, San Francisco, CA (US)

(73) Assignee: Raven Resonance, Inc., San Francisco, CA (US)

(21) Appl. No.: 19/415,489

(22) Filed: Dec. 10, 2025

Related U.S. Application Data
(60) Provisional application No. 63/733,600, filed on Dec. 13, 2024.

(51) Int. Cl. H01M 50/269; H01M 50/209; H01M 50/244; H01M 50/256; H01M 50/271; H02J 7/00; H02J 7/34; H02J 50/10

(52) U.S. Cl. CPC H01M 50/269; H01M 50/244; H01M 50/256; H01M 50/271; H02J 7/342; H02J 7/345; H02J 7/751; H02J 50/10; H01M 50/209; H02J 2207/50

(57) ABSTRACT

A battery case for storing and/or charging swappable batteries comprises a base, a cover, a raising/lowering system and a charging system. The raising/lowering system includes at least one battery carrier, preferably two battery carriers, that can raise the batteries out of recesses when the cover is opened, such that the batteries appear as a pair of wings when raised. The raising/lowering system includes at least one linkage bar that pivots to engage a built-in hinge lever of the cover on one end and the battery carriers on the other end. The charging system comprises at least one electrical contact disposed on at least one battery carrier or the base to contact at least one battery contact of the battery or batteries when the case is opened and/or closed. The battery case allows users to conveniently access, swap, and charge batteries.

### RELATED APPLICATION

This patent application relates to and claims priority from U.S. Provisional Patent Application No. 63/733,600 entitled “Storage Case for Batteries for Wearable Electronic Devices” filed Dec. 13, 2024 and is incorporated herein by reference including its specification.

### FIELD OF THE INVENTION

The present invention is directed to a storage and charging case for swappable batteries for use with wearable electronic devices, in particular smart glasses and similar devices. The batteries of the type described in co-pending provisional application No. 63/694,486, are designed to be interchangeable with batteries in use on smart glasses and similar devices when the charge of the current device is low or depleted. The storage and charging case includes a base for holding the batteries, a cover to enclose the batteries in the base, electrical contacts to charge the batteries when stored in the case, and a mechanism that raises or presents the batteries for ease of removal when the necessary.

### BACKGROUND OF THE INVENTION

Wearable electronic devices, such as smart glasses, have become much more common in recent years. The need for powering such devices is paramount, particularly continuously powering such devices without interruption. In addition, users want to continue to use such devices without interruption, such as to connect to a recharging source.

Under current technology, user's must remove wearable devices in order to re-charge them. In addition, if a user wants to replace a battery on such a wearable device, the device typically needs to be shut-down or restarted, because the power is completely disconnected.

The proliferation of such electronic devices and accessories thereof necessitates a need for convenient and protective carrying of such accessories. The inventive battery case provides a convenient and secure device for carrying replacement batteries, such that the same a less likely to be lost or separated from the user or the device with which they are intended to be used. In addition, the inventive battery case includes certain mechanisms for easily removing the batteries from the case.

Accordingly, there is a need for an improved case for swappable batteries for use with wearable electronic devices that provides for convenient carrying, transporting, charging, and utilizing of said batteries. The present invention fulfills these needs and provides other related advantages.

### SUMMARY OF THE INVENTION

The present invention has been developed in response to the present state of the art, and in particular, in response to the problems and needs in the continuous, uninterrupted use and operation of wearable electronic devices. Such invention relates to a storage and charging case for batteries that allow for convenient access to and replacement of one or more batteries on such electronic devices. In particular, for smart glasses or similar electronic devices, an enclosed case the stores, protects and charges such batteries, and then presents the batteries for easy removal and replacement is desirable.

A core component of the smart glasses concept is a system of modular or swappable batteries, which for example, are sometimes referred to as “wings” in particular presentations according to the present invention. The user would have a set of two batteries installed on the glasses, i.e., one on each arm, such as behind the user's ears. A user might bring along extra batteries—at least one extra battery but preferably two or more. One advantage of this replaceable battery concept is that instead of requiring a full-sized glasses case for recharging, the extra batteries may be carried in a smaller case, more similar to the case size of many popular wireless earbuds which are easy to carry or pocket.

The battery case preferably has an action which presents the batteries to the user by raising/lowering the batteries, i.e., “flapping wings”, so that they rotate up out of the case when the list is opened and rotate down into the case when the lid is closed. The case may consist of a static base, and a carrier component which moves in the raising/lowering motion. The batteries connect and disconnect from this carrier component, such that they move along with the carrier when the lid is opened or closed. The case shown carries a set of 2, which makes sense as a common carry option so that one set of batteries can be swapped with a second freshly charged set of batteries throughout the day, but the case could contain any number of batteries.

The battery case preferably uses a mechanical coupling from the action of opening the lid to raise the batteries in sync with the opening of the lid. This mechanical coupling is preferably configured such that the raising/lowering motion prevents collisions between the batteries and the lid. The mechanism may be spring loaded toward the open or closed position to protect the mechanism from damage if the lid is blocked, or opened too quickly, or if the batteries and lid are forced opposite each other along their intended motion. The illustrated embodiment shows a pair of symmetrical batteries raising/lowering, i.e., flapping, apart from each other from a set of centrally located pivots, but the batteries could move in a different axis, together on the same or separate carrier, or could be asymmetrical in orientation.

Electrical charging connections may run through the carrier hinge, or may occur from a set of contacts through the batteries or carrier which only connect when the lid is closed. The same coupled motion may also interact with the carrier attachment mechanism, for example, by using the opening lid motion to also unlock a latch holding the batteries in place, or partially push or detach the batteries from the carrier when opened. Finally, the case may also connect to the user's phone or the or smart glasses frames with a wireless connection, and there may be sensors to indicate the presence or status the batteries in the case. This status could be indicated on the case to the user, or communicated to the frames or phone.

The “flapping” motion serves two primary functions. The first is to provide easier access to the user for attaching and detaching the batteries. The batteries will have an alignment and attachment mechanism to the frames, and the same attachment could be used to connect the batteries to the case, and maintain connection along the power contacts for charging. Moving the battery up out of the case gives more room for the users fingers as they hold and maneuver the batteries. Alternatively, a secondary or partial attachment could be used for the case, which makes use of all, some, or none of the attachment geometry between the batteries and the frame.

The second function is to add engaging motion and haptic or “fidget” appeal to the case. Opening and using the case could be a joyful experience for the user which feels satisfying, and presenting the batteries to the user from the case elevates the experience of swapping the batteries throughout the day.

Finally the case may have a roughly rectangular shape as shown, or could take a more rounded or puck shaped form. The lid could have a variety of closure or latching components and may be fully or partially spring loaded open or closed, held in either position by a latch or detent. The lid may also be opened directly as shown, or by a separate secondary mechanism, such as a sliding knob or release button.

The present invention is directed to a battery case including a base with at least one recess for receiving at least one battery, a cover pivotally connected to the base and including a hinge lever proximate to the base, at least one battery carrier pivotally disposed on the base within the at least one recess, the at least one battery carrier configured to receive and retain the at least one battery.

A linkage bar is pivotally disposed in the base engaging at a first end with the hinge lever and engaging at a second end with the at least one battery carrier. The at least one battery carrier is configured to raise from the at least one recess upon opening of the cover through the engagement of the hinge lever with the first end of the linkage bar. As the linkage bar pivots, the second end of the linkage bar engages with the at least one battery carrier to raise the battery carrier.

The base may have a first recess with a corresponding first battery carrier pivotally disposed in the first recess and configured to receive and retain a first battery. The base may also have a second recess with a corresponding second battery carrier pivotally disposed within the second recess and configured to receive and retain a second battery. In this form. the linkage bar preferably engages at the second end simultaneously with the first battery carrier and the second battery carrier.

The engagement of the first end of the linkage bar with the hinge lever is configured in a manner that the hinge lever does not engage the first end of the linkage bar until the cover is approximately half-way open. In this way, the at least one battery carrier does not begin to raise from the at least one recess until the cover is approximately half-way open. Similarly, with both a first recess and a second recess, the first battery carrier and the second battery carrier both do not begin to raise form the corresponding first and second recesses until the cover is approximately half-way open.

The linkage bar is preferably biased to lower the at least one battery carrier to the at least one recess when the cover is approximately half-way closed. Similarly, the cover hinge is leveraged to maintain the cover fully open or fully closed.

The battery case preferably also includes a charging system and is adapted to charge the at least one battery. The charging system includes at least one base electrical contact disposed in the at least one recess or on the at least one battery carrier and configured to electrically engage at least one battery electrical contact on the at least one battery. An electrical storage component is also included and is electrically connected to the at least one base electrical contact.

The charging system further includes an external electrical input electrically connected to the electrical storage component. The electrical storage component preferably comprises a storage capacitor or a storage battery.

Similarly, when the battery case includes first and second recesses, the charging system is adapted to charge both the first battery and the second battery. The charging system includes a first base electrical contact disposed in the first recess or on the first battery carrier and a second base electrical contact disposed in the second recess or on the second battery carrier. The first base electrical contact is configured to electrically engage with a battery electrical contact on the first battery; and the second base electrical contact is configured to electrically engage with a battery electrical contact on the second battery. The electrical storage component is electrically connected to the first base electrical contact and the second base electrical contact.

Other features and advantages of the present invention will become apparent from the following more detailed description, taken in conjunction with the accompanying drawings, which illustrate, by way of example, the principles of the invention.

### BRIEF DESCRIPTION OF THE FIGURES

These and other features and advantages of the present invention will become appreciated, as the same becomes better understood with reference to the specification, claims and drawings herein:

FIG. 1 is an elevated perspective view of an embodiment of a battery case with the cover closed embodying the present invention;

FIG. 2 is an opposite side elevated perspective view of an embodiment of a battery case with a partially open cover embodying the present invention;

FIG. 2A is a perspective view of the battery case of FIG. 2 with a fully open cover embodying the present invention;

FIG. 3 is a partially transparent side view of the battery case of FIG. 2;

FIG. 3A is a partially transparent side view of the battery case of FIG. 3 with the cover open slightly more;

FIG. 3B is a partially transparent side view of the battery case of FIG. 3A with the cover open slightly more;

FIG. 3C is a partially transparent side view of the battery case of FIG. 3B with the cover open fully;

FIG. 4 is a cross-sectional view of the battery case of FIG. 3 taken along longitudinal mid-line 4-4 of FIG. 2;

FIG. 4A is a cross-sectional view of the battery case of FIG. 3A taken along longitudinal mid-line 4-4 of FIG. 2;

FIG. 4B is a cross-sectional view of the battery case of FIG. 3B taken along longitudinal mid-line 4-4 of FIG. 2;

FIG. 4C is a cross-sectional view of the battery case of FIG. 3C taken along longitudinal mid-line 4-4 of FIG. 2;

FIG. 5 is a cross-sectional view of the battery case of FIG. 3 taken along latitudinal mid-line 5-5;

FIG. 5A is a cross-sectional view of the battery case of FIG. 3A taken along latitudinal mid-line 5A-5A;

FIG. 5B is a cross-sectional view of the battery case of FIG. 3B taken along latitudinal mid-line 5B-5B;

FIG. 5C is a cross-sectional view of the battery case of FIG. 3C taken along latitudinal mid-line 5C-5C;

FIG. 6 is a close-up of an interior cross-section of the battery case of FIG. 5B illustrating an embodiment of electrical contacts;

FIG. 7 is a close-up of an interior cross-section of the battery case of FIG. 5B illustrating an alternate embodiment of electrical contacts;

FIG. 8 is a close-up of an interior cross-section of the battery case of FIG. 5B illustrating an another alternate embodiment of electrical contacts;

FIG. 9 is a lowered perspective, partially transparent view of a battery case and charging components;

FIG. 10 is a lowered perspective, partially transparent view of a battery case and an alternate embodiment of charging components.

### DETAILED DESCRIPTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

It will be understood that when an element is referred to as being “on” another element, it can be directly on the other element or intervening elements may be present there between. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section.

As used herein, the singular forms “a,” “an,” and “the,” are intended to include the plural forms as well, unless the context clearly indicates otherwise. It will be further understood that the terms “comprises” and/or “comprising,” “includes” and/or “including,” and “have” and/or “having,” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom,” and “upper” or “top,” “inner” or “outer,” and “medial” or “lateral” may be used herein to describe one element's relationship to other elements as illustrated in the Figures. It will be understood that relative terms are intended to encompass different orientations of the device in addition to the orientation depicted in the Figures.

Unless otherwise defined, all terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing.

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The invention described herein is primarily concerned with the storage and charging of batteries used in wearable electronic devices such as smart glasses and similar wearable technology. This patent is not necessarily concerned with the function and operation of the batteries beyond the storage and charging thereof. Features of wearable devices and electrical connections to batteries are intended to conform to the current state of the art of such features, or as such state of the art may develop in the future.

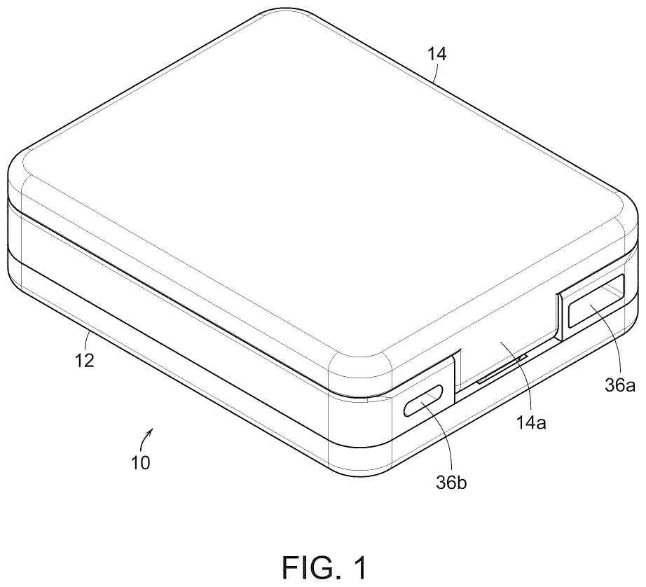

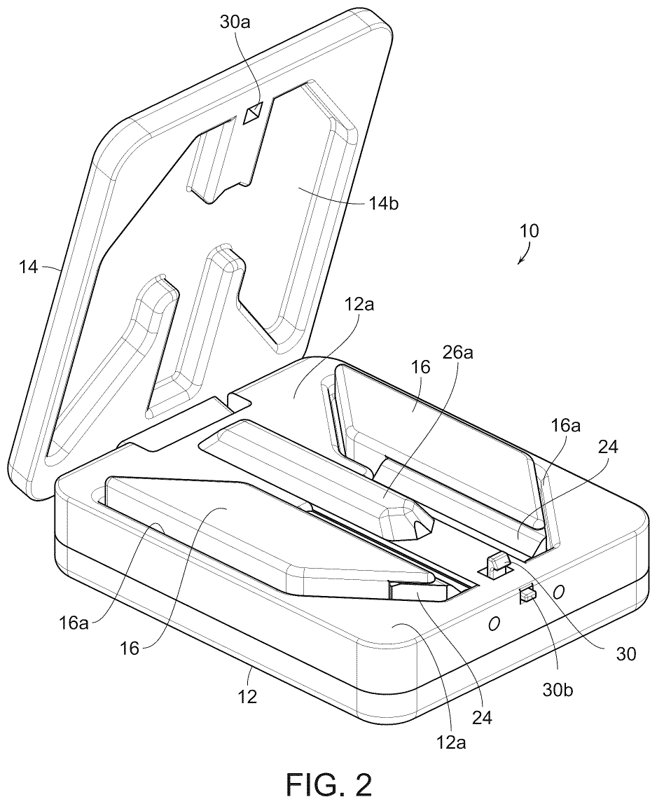

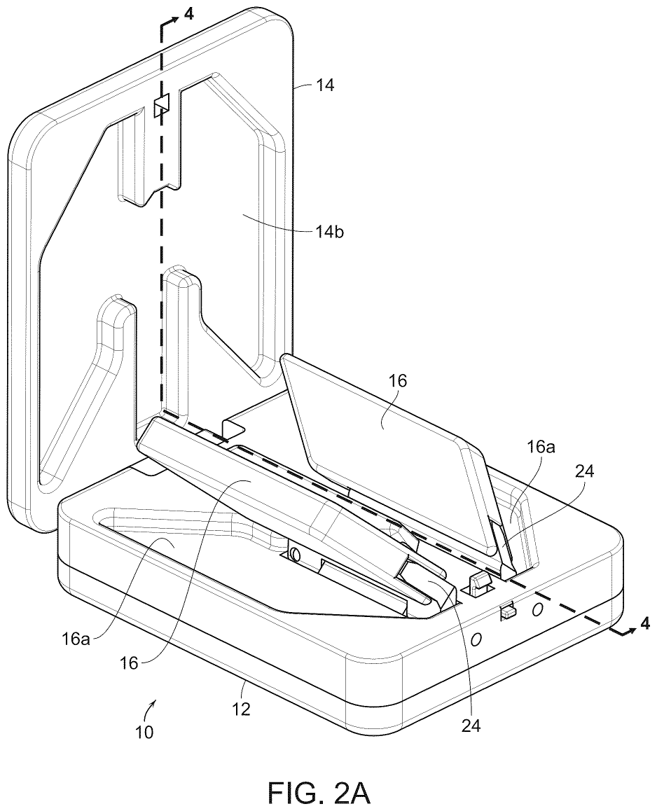

As shown in FIGS. 1 and 2, the present invention is directed to a battery case generally referred to by reference numeral 10. The battery case 10 includes a base 12 and a hinged cover 14 (hinge 14a) that is designed to enclose at least one battery 16, preferably two batteries 16, but potentially three or more batteries for use with wearable electronic devices, such as smart glasses (not shown). The battery case 10 is designed for storage and protection of the batteries 16, as well as charging of the batteries 16. The batteries 16 are preferably modular or swappable with other batteries for charging while others are being used and/or hot swapping batteries while the wearable electronic devices are being used.

Further, the battery case 10 is designed with a linkage system (described more fully below), preferably operatively connected to the opening of the hinged cover 14, that pivots or raises the batteries 16 on battery carriers 24 from the base 12 for ease of access and removal. As shown in FIGS. 2 and 2A, the base 12 preferably includes one or more recesses 16a configured by size and shape to receive the one or batteries 16 and battery carriers 24 so that they only partially protrude above a top surface 12a of the base 12. The cover 14 may include corresponding recesses 14b to receive those portions of the batteries 16 and battery carriers 24 and any other structures that protrude above the top surface 12a of the base 12.

Preferably, the cover 14 is designed such that it does not engage with the linkage system until it is mostly open so as to avoid collisions between the cover 14 and the batteries 16 being raised. This delayed engagement of the hinge lever 18 with the linkage bar 20 is illustrated in the differences between FIGS. 2 and 2A. In FIG. 2, the cover 14 is approximately half-way open and the batteries 16 are still lowered in the recesses 16a. In FIG. 2A, the cover 14 is fully open and the batteries 16 are fully raised up from the base 12. The hinge 14a is preferably biased or leveraged as by a spring 15 or corresponding eccentric lobes or ridges, such that the cover 14 is maintained in a closed position or an open position unless acted upon by sufficient force to overcome the bias or leverage.

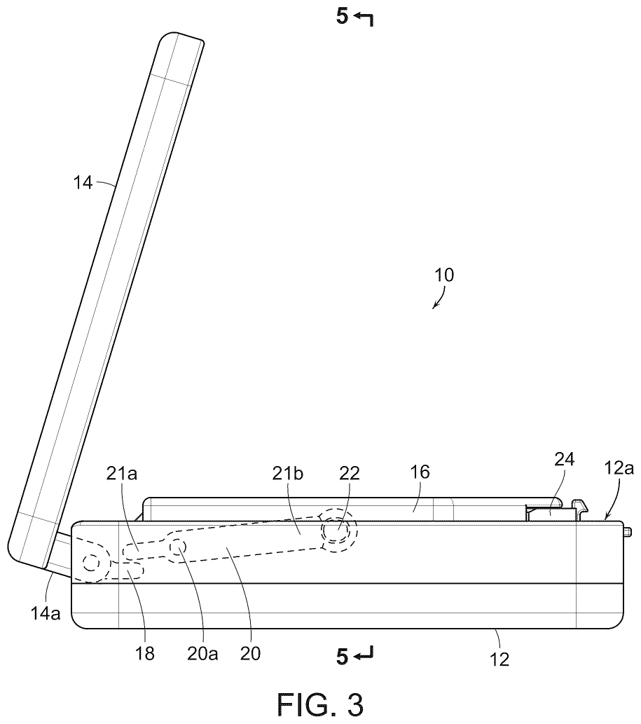

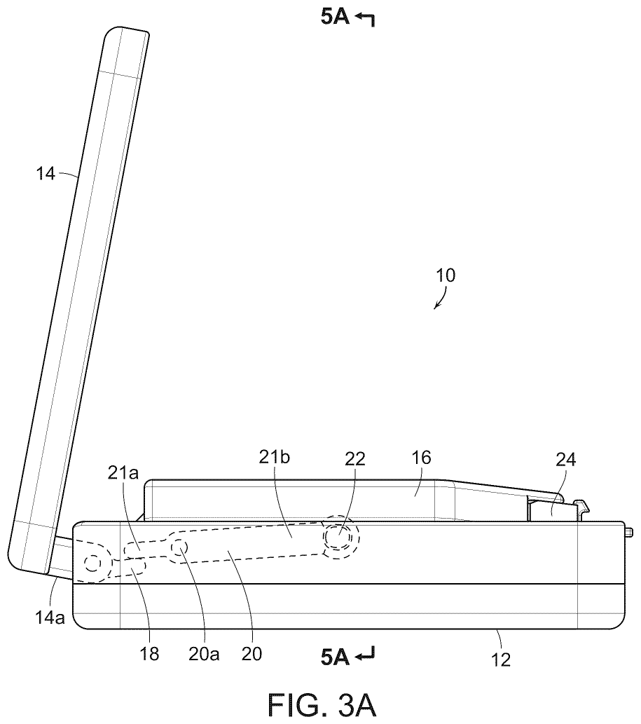

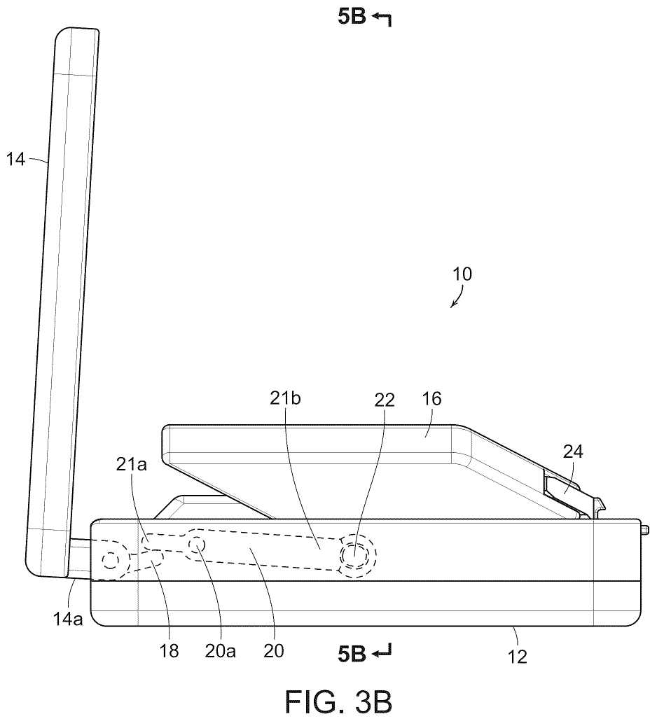

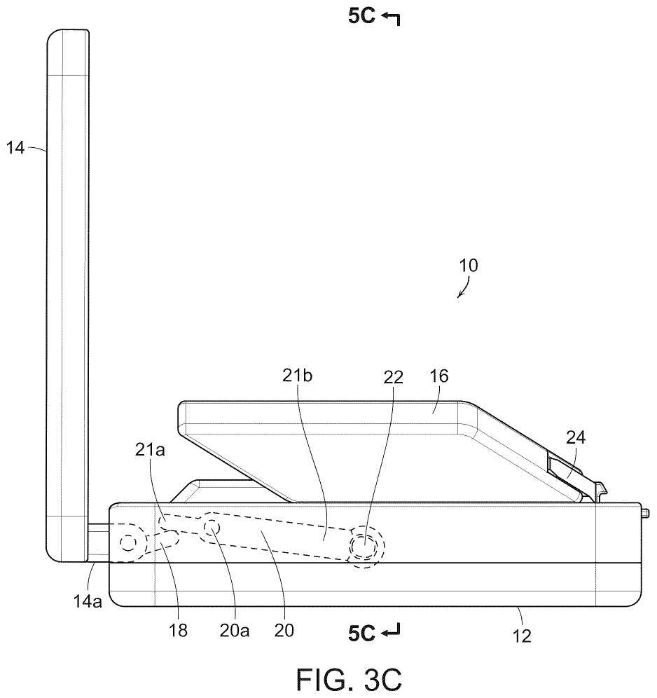

The hinge 14a of the cover 14 preferably includes a built-in hinge lever 18 that exerts a force on a linkage bar 20 when the cover 14 is raised to the open position. As shown in FIGS. 3, 3A, 3B, and 3C, the linkage bar 20 pivots about pivot point 20a in response to the force from the hinger lever 18 of the cover hinge 14a. As a first portion 21a of the linkage bar 20 on one side of the pivot point 20a is raised by the hinge lever 18, a second portion 21b of the linkage bar 20 on the opposite side of the pivot point 20a is lowered. This lowering of the second portion 21b of the linkage bar 20 exerts a downward force on a carrier pin 22 (or raising/lowering lever), which in turn rotates the battery carrier 24 up, along with the battery 16. The linkage bar 20 is preferably spring biased or otherwise similarly leveraged to return to a neutral position where the hinge lever 18 exerts no force on the linkage bar 20 and the battery carrier 24 is fully lowered into the recess 16a. Similarly, the hinge 14a of the cover 14 may include a spring or other biasing mechanism to keep the cover 14 open in a neutral position and/or fully closed.

FIG. 3 illustrates the cover 14 in an open, neutral position where the hinge lever 18 exerts no force on the linkage bar 20 and the battery carriers 24 are fully lowered. FIG. 3A illustrates the cover 14 in slightly more open position than FIG. 3, where the hinge lever 18 begins to exert a force on the linkage bar 20 so as to slightly raise the battery carriers 24 from the recesses 16a, compared to FIG. 3. FIG. 3B illustrates the cover 14 in slightly more open position than FIG. 3A, where the hinge lever 18 exerts a greater force on the linkage bar 20 so as to significantly raise the battery carriers 24 from the recesses 16a, compared to FIG. 3A. FIG. 3C illustrates the cover 14 in a fully open position, where the hinge lever 18 has pivoted the linkage bar 20 so as to fully raise the battery carriers 24 from the recesses 16a, compared to FIG. 3B. The opposite action is observed when the cover 14 is moved from the fully open position to the closed position.

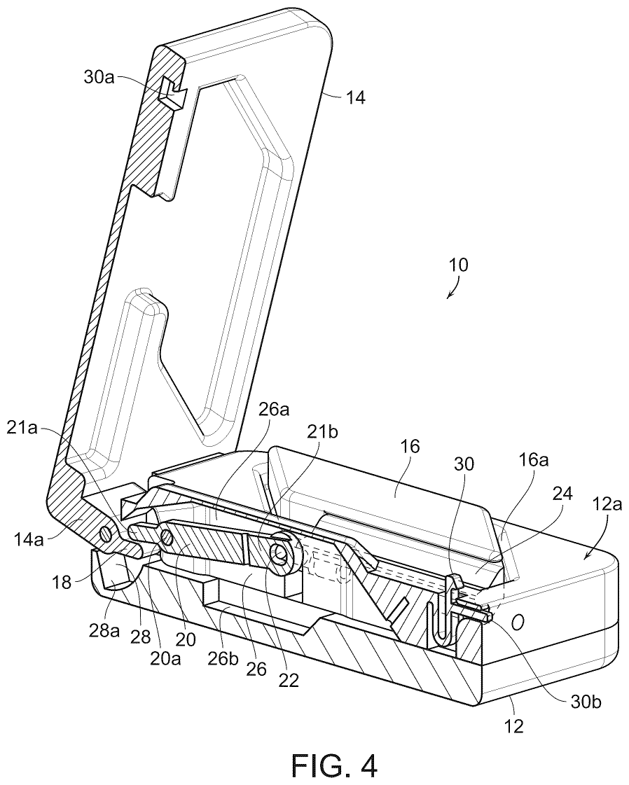

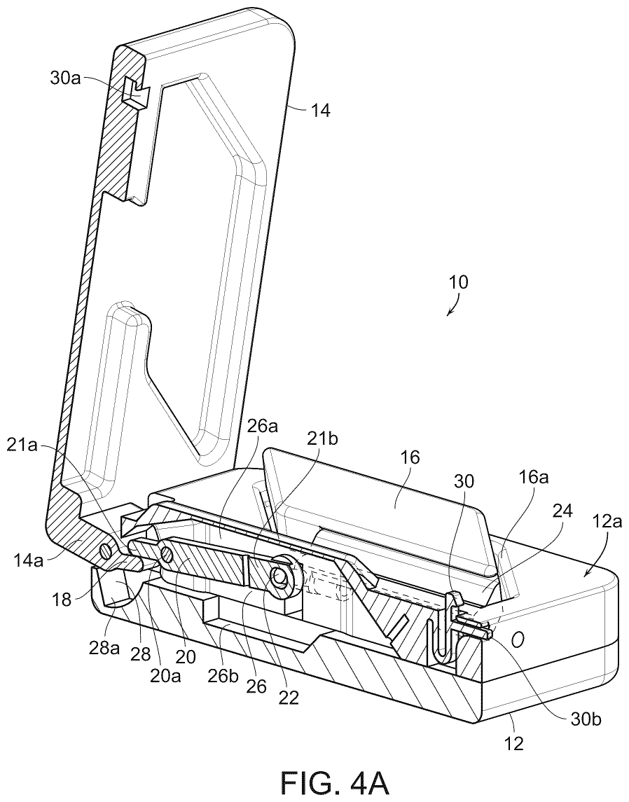

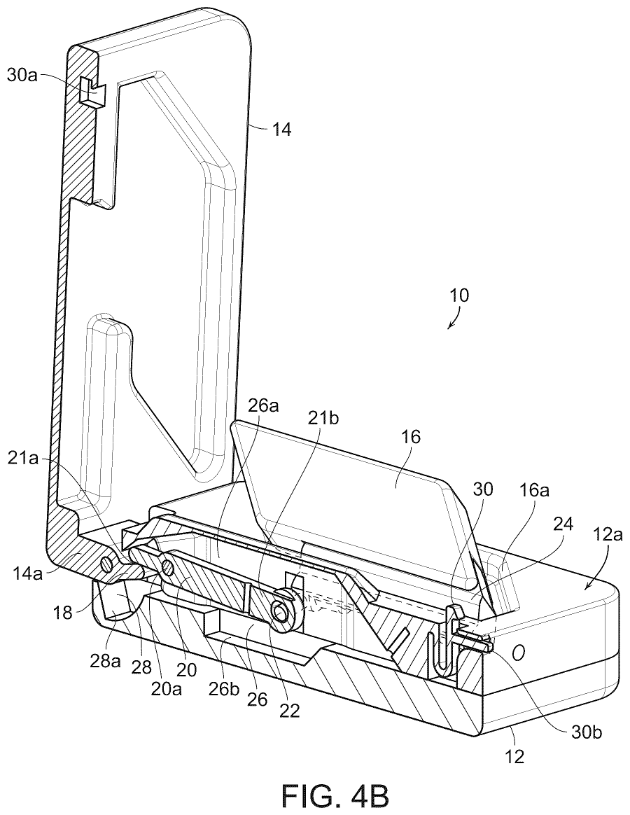

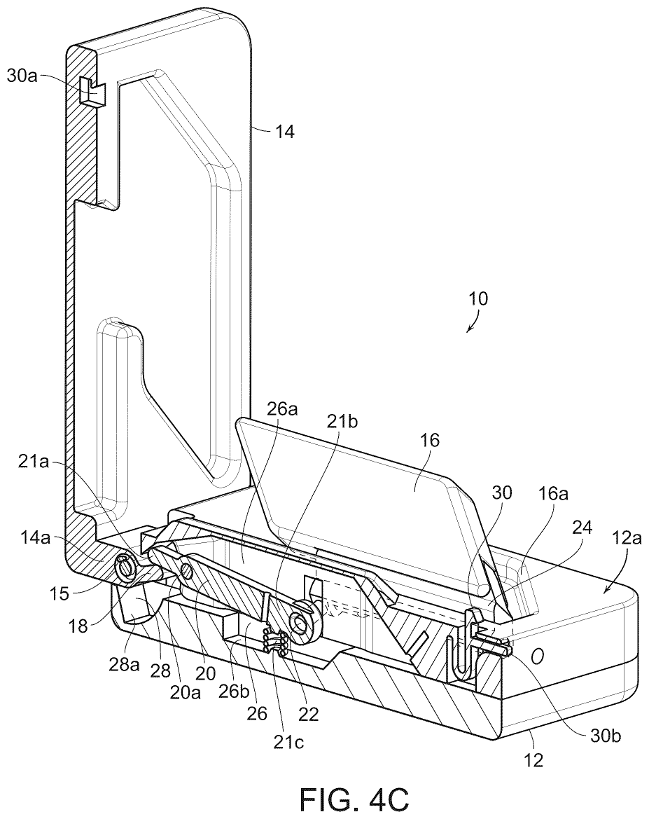

FIGS. 4, 4A, 4B, and 4C similarly illustrate the functional connection of the opening of the cover 14 to the raising of the battery carriers 24, but in longitudinal cross-section. FIG. 4 illustrates the cover 14 in an open, neutral position similar to FIG. 3, where the hinge lever 18 exerts no force on the linkage bar 20 and the battery carriers 24 are fully lowered. FIG. 4A illustrates the cover 14 in slightly more open position similar to FIG. 3A, where the hinge lever 18 begins to exert a force on the linkage bar 20 so as to slightly raise the battery carriers 24 from the recesses 16a, compared to FIG. 4. FIG. 4B illustrates the cover 14 in an even more open position similar to FIG. 3B, where the hinge lever 18 exerts a greater force on the linkage bar 20 so as to significantly raise the battery carriers 24 from the recesses 16a, compared to FIG. 4A. FIG. 4C illustrates the cover 14 in a fully open position similar to FIG. 3C, where the hinge lever 18 has pivoted the linkage bar 20 so as to fully raise the battery carriers 24 from the recesses 16a, compared to FIG. 4B. The opposite action is observed when the cover 14 is moved from the fully open position to the closed position.

As shown in FIGS. 4-4C, the interior of the base 12 includes a linkage cavity 26 for containing the linkage bar 20. The linkage cavity 26 includes an upper region 26a and a lower region 26b that allows for a full range of pivoting by the linkage bar 20, particularly the second portion 21b which preferably has a greater length and moment arm extending from the pivot point 20a as compared to the first portion 21a. Similarly, the interior of the base 12 includes a hinge cavity 28 for containing the hinge 14a and hinge lever 18. The hinge cavity 28 includes a lower region 28a that receives the hinge lever 18 when the cover 14 is moved into a fully closed position. The hinge lever 18 and first portion 21a of the linkage bar 20 engage in a space connecting the linkage cavity 26 and hinge cavity 28. The linkage bar 20 is preferably biased by a spring or similar resilient mechanism 21c such that the linkage bar 20 is forced to a position that lowers the battery carriers 24 into the recesses 16a, unless the hinge lever 14a is engaged with the first portion 21a of the linkage bar 20 so as to pivot against the bias.

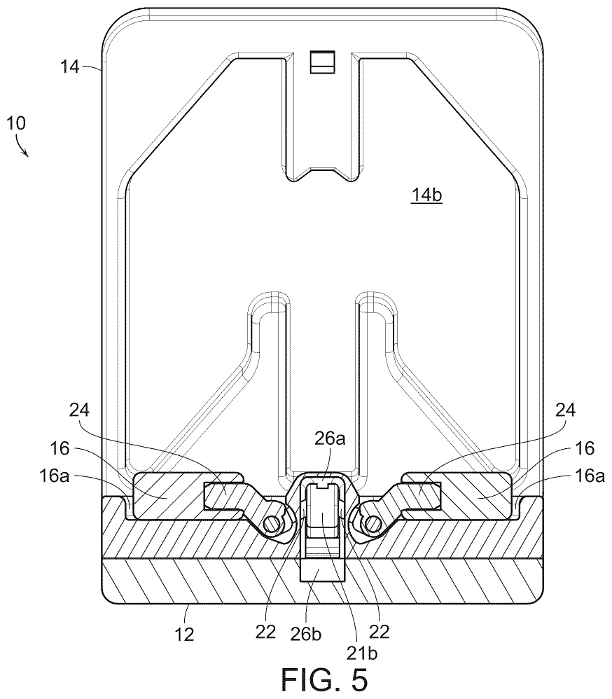

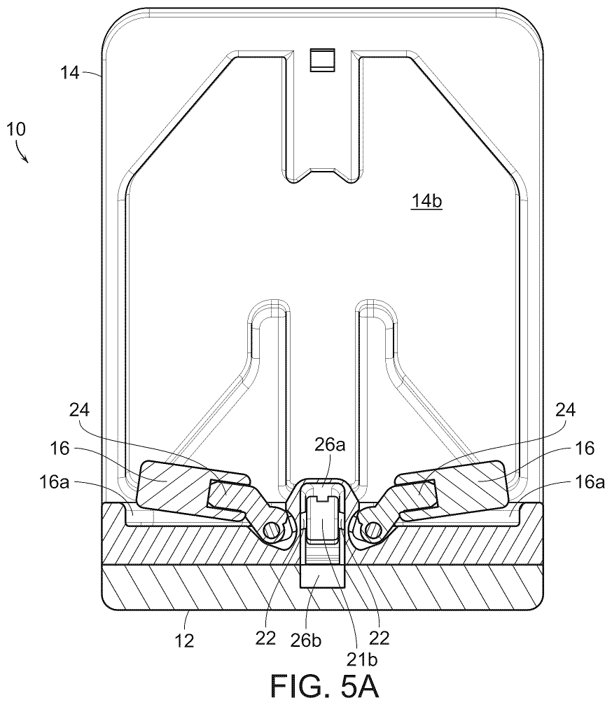

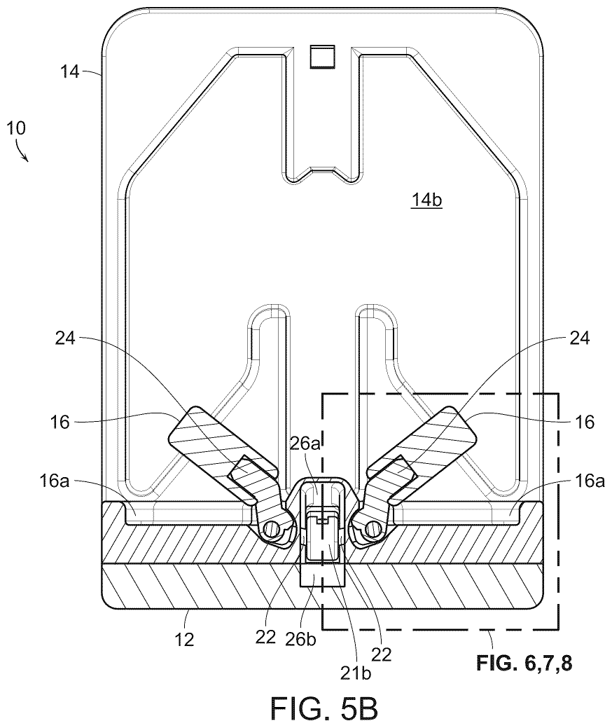

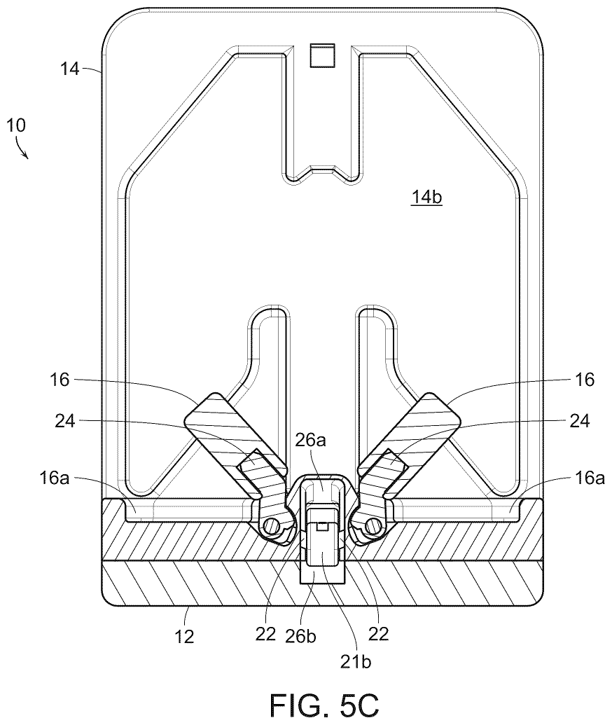

FIGS. 5, 5A, 5B, and 5C similarly illustrate the functional connection of the opening of the cover 14 to the raising of the battery carriers 24, but in latitudinal cross-section. FIG. 5 illustrates the cover 14 in an open, neutral position similar to FIG. 3, where the hinge lever 18 exerts no force on the linkage bar 20 and the battery carriers 24 are fully lowered. FIG. 5A illustrates the cover 14 in slightly more open position similar to FIG. 3A, where the hinge lever 18 begins to exert a force on the linkage bar 20 so as to slightly raise the battery carriers 24 from the recesses 16a, compared to FIG. 5. FIG. 5B illustrates the cover 14 in an even more open position similar to FIG. 3B, where the hinge lever 18 exerts a greater force on the linkage bar 20 so as to significantly raise the battery carriers 24 from the recesses 16a, compared to FIG. 5A. FIG. 5C illustrates the cover 14 in a fully open position similar to FIG. 3C, where the hinge lever 18 has pivoted the linkage bar 20 so as to fully raise the battery carriers 24 from the recesses 16a, compared to FIG. 5B. The opposite action is observed when the cover 14 is moved from the fully open position to the closed position.

While the drawing figures generally show two carriers 24 and a cut-away cross-section of the base 12 only shows one carrier 24, the battery case 10 preferably includes at least two carriers 24 symmetrically disposed about a mid-line of the case 10, with the linkage bar 20 acting symmetrically on carrier pins 22 for each carrier 24 at the same time. Alternatively, there may be a second linkage bar 20 for the second carrier 24 disposed adjacent to the first linkage bar 20 for the first carrier 24. For increasing numbers of carriers, there may be a corresponding increased number of linkage bars 20.

FIGS. 3, 4, and 5, further illustrate other features of the battery case 10, including a cover latch 30 and a cover notch 30a. When the cover latch 30 and cover notch 30a engage, the cover 12 is retained in the closed position until a latch release 30b is triggered. The cover latch 30 and cover notch 30a are preferably configured with chamfered or angled surfaces such that they automatically engage upon closing the cover 12, but cannot be separated unless the latch release 30b is triggered.

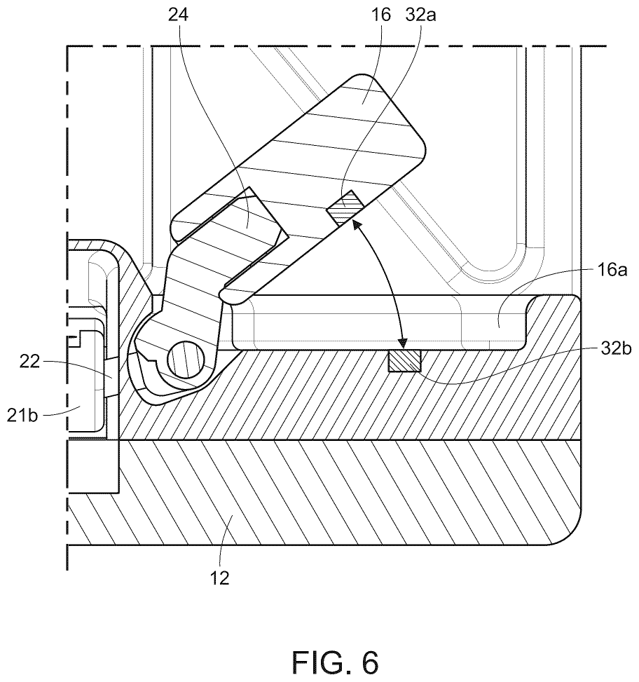

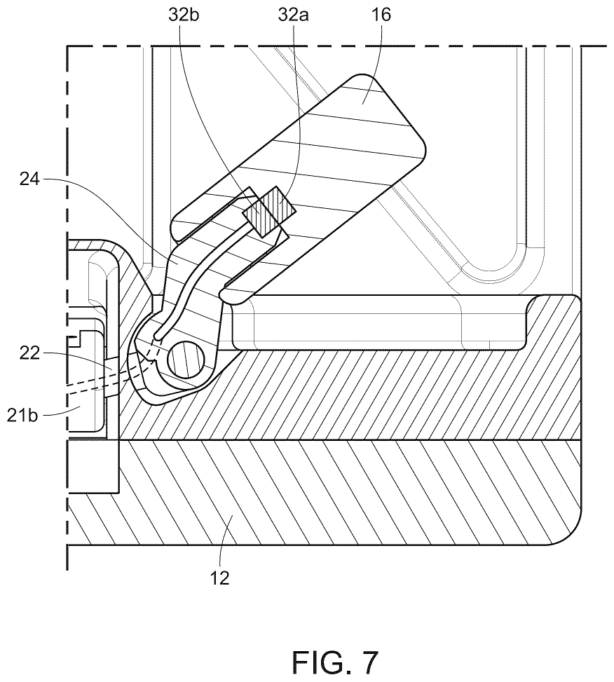

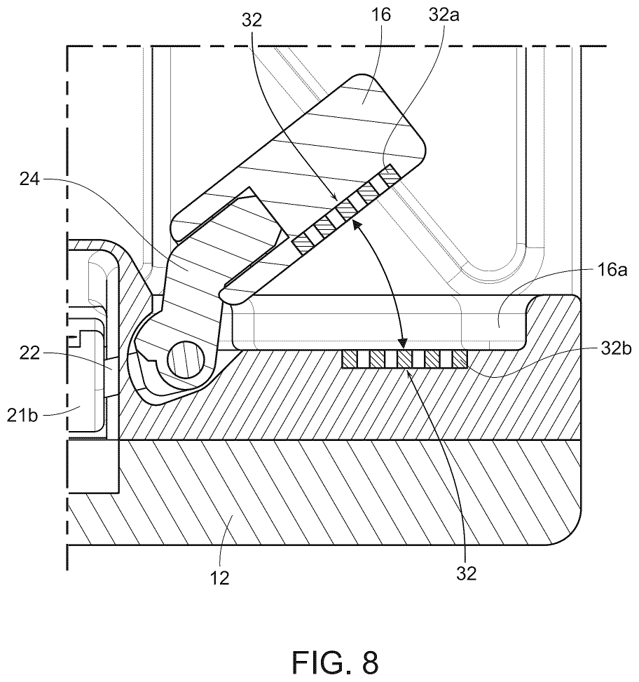

FIGS. 6, 7, and 8 illustrate varying embodiments of electrical connections in the battery case 10 relative to the batteries 16. In FIG. 6, a first embodiment is shown where the battery 16 is disposed on the battery carrier 24, with mating electrical contacts—a battery contact 32a on a side of the battery and a base electrical contact 32b in the recess 16a, such that the two contacts make an electrical connection only when the cover 12 is sufficiently closed that the battery 16 is fully received in the recess 16a. In FIG. 7, a second embodiment is shown where the battery 16 is disposed on the battery carrier 24, with mating electrical contacts—a battery contact 32a in a channel on the battery and a base electrical contact 32b on the battery carrier 24, such that the two contacts make an electrical connection as soon as the battery 16 is positioned on a carrier 24, regardless of whether the cover 12 is open or closed, or the battery 16 is received in the recess 16a. In FIG. 8, an alternate embodiment of the electrical connection shown in FIG. 6 is illustrated. In this alternate embodiment, the battery 16 includes a plurality of battery contacts 30a and the base 12 includes a matching plurality of base electrical contacts 32b. Such multiple contacts can facilitate rapid charging or provide other functional connections, e.g., data transfer or programming updates.

As shown in the figures and referenced in the brief descriptions of the drawings, the case 10 preferably includes one or more electrical contacts 32 for charging batteries 16 stored in the case. The contemplated electrical contacts 32 are schematically illustrated as square contacts, which may include a single contact or multiple contacts, e.g., positive and negative. In particularly preferred embodiments, the case 10 may include more than two contacts 32 for each battery 16 so as to provide increased power flow for each battery 16 to increase the rate of charge. A corresponding electrical connection, i.e., wire, preferably passes from the contacts through the carrier 24, linkage bar 20, and/or base 12 to an electrical storage component 34 in the case 10. The electrical storage component 34 is preferably either a capacitor designed to directly pass a steady electrical charge to the base electrical contacts 32b, or a battery designed to store a persistent electrical charge for passing to the base electrical contacts 32b when an electrical circuit is completed.

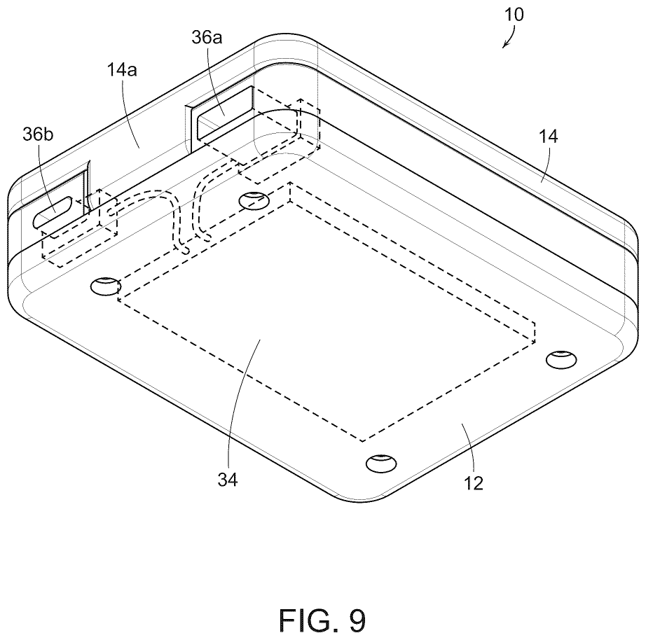

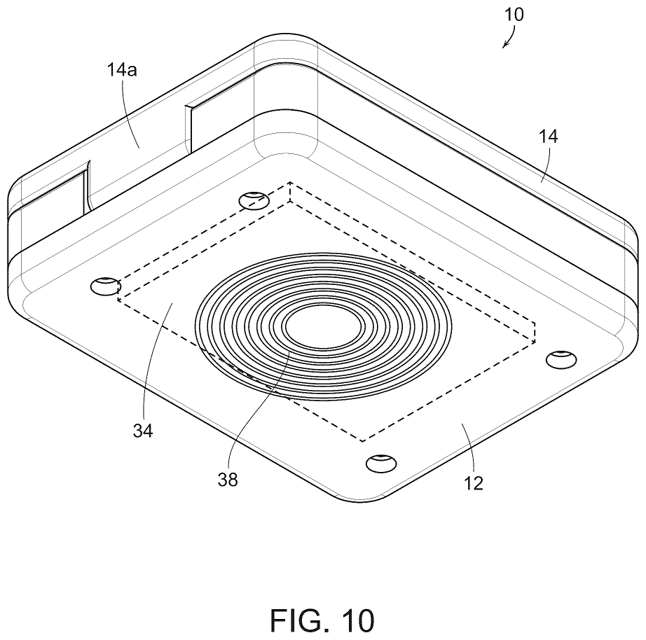

The electrical storage component 34 is preferably charged from external inputs, e.g., USB and/or wireless charging coil. FIGS. 9 and 10 illustrate alternate embodiments of the storage battery 34 and the input options. In FIG. 9, external inputs in the form of a USB port 36a and USB-c port 36b are both shown, electrically connected to the storage battery 34. In FIG. 10, the external USB inputs are removed and an induction coil 38 is disposed in the bottom surface of the base 12 adjacent to the storage battery 34. The induction coil 38 is configured to receive a wireless charge from an external source and transfer the charge to the storage battery 34.

Although several embodiments have been described in detail for purposes of illustration, various modifications may be made without departing from the scope and spirit of the invention.

1. A battery case, comprising:
a base having at least one recess for receiving at least one battery;
a cover pivotally connected to the base and including a hinge lever proximate to the base;
at least one battery carrier pivotally disposed on the base within the at least one recess, the at least one battery carrier configured to receive and retain the at least one battery; and
a linkage bar pivotally disposed in the base engaging at a first end with the hinge lever and engaging at a second end with the at least one battery carrier, wherein the at least one battery carrier is configured to raise from the at least one recess upon opening of the cover through the engagement of the hinge lever with the first end of the linkage bar, pivoting of the linkage bar, and the engagement of the second end of the linkage bar with the at least one battery carrier.

2. The battery case of claim 1, wherein the base has a first recess and a second recess, a first battery carrier pivotally disposed within the first recess and configured to receive and retain a first battery, and a second battery carrier pivotally disposed within the second recess and configured to receive and retain a second battery.

3. The battery case of claim 2, the linkage bar engaging at the second end simultaneously with the first battery carrier and the second battery carrier.

4. The battery case of claim 1, wherein the engagement of the first end of the linkage bar with the hinge lever is configured in a manner that the hinge lever does not engage the first end of the linkage bar until the cover is approximately half-way open, such that the at least one battery carrier does not raise from the at least one recess until the cover is approximately half-way open.

5. The battery case of claim 4, wherein the linkage bar is biased to lower the at least one battery carrier to the at least one recess when the cover is approximately half-way closed.

6. The battery case of claim 5, wherein the cover hinge is leveraged to maintain the cover fully open or fully closed.

7. The battery case of claim 1, further comprising a charging system disposed in the battery case and adapted to charge the at least one battery, wherein the charging system comprises:
at least one base electrical contact disposed in the at least one recess or on the at least one battery carrier and configured to electrically engage at least one battery electrical contact on the at least one battery; and
an electrical storage component electrically connected to the at least one base electrical contact.

8. The battery case of claim 7, further comprising an external electrical input electrically connected to the electrical storage component, wherein the electrical storage component comprises a storage capacitor or a storage battery.

9. The battery case of claim 2, further comprising a charging system disposed in the battery case and adapted to charge the first battery and the second battery, wherein the charging system comprises:
a first base electrical contact disposed in the first recess or on the first battery carrier;
a second base electrical contact disposed in the second recess or on the second battery carrier;
wherein the first base electrical contact is configured to electrically engage with a battery electrical contact on the first battery;
wherein the second base electrical contact is configured to electrically engage with a battery electrical contact on the second battery; and
an electrical storage component electrically connected to the first base electrical contact and the second base electrical contact.

10. A battery case, comprising:
a base having first recess for receiving a first battery and a second recess for receiving a second battery;
a cover pivotally connected to the base and including a hinge lever proximate to the base;
a first battery carrier pivotally disposed on the base within the first recess and configured to receive and retain the first battery, and a second battery carrier pivotally disposed on the base within the second recess and configured to receive and retain the second battery; and
a linkage bar pivotally disposed in the base engaging at a first end with the hinge lever and engaging at a second end with the first battery carrier and the second battery carrier, wherein the first battery carrier is configured to raise from the first recess and the second battery carrier is configured to raise from the second recess, simultaneously upon opening of the cover through the engagement of the hinge lever with the first end of the linkage bar, pivoting of the linkage bar, and the engagement of the second end of the linkage bar with the first battery carrier and the second battery carrier.

11. The battery case of claim 10, wherein the engagement of the first end of the linkage bar with the hinge lever is configured in a manner that the hinge lever does not engage the first end of the linkage bar until the cover is approximately half-way open, such that the first battery carrier does not raise from the first recess and the second battery carrier does not raise from the second recess until the cover is approximately half-way open.

12. The battery case of claim 10, wherein the linkage bar is biased to lower the first battery carrier into the first recess and the second battery carrier into the second recess when the cover is approximately half-way closed.

13. The battery case of claim 12, wherein the cover hinge is leveraged to maintain the cover fully open or fully closed.

14. The battery case of claim 10, further comprising a charging system disposed in the battery case and adapted to charge the first battery and the second battery, wherein the charging system comprises:
a first base electrical contact disposed in the first recess or on the first battery carrier and configured to electrically engage a battery electrical contact on the first battery;
a second base electrical contact disposed in the second recess or on the second battery carrier and configured to electrically engage a battery electrical contact on the second battery; and
an electrical storage component electrically connected to the first base electrical contact and the second base electrical contact.

15. The battery case of claim 14, further comprising an external electrical input electrically connected to the electrical storage component, wherein the electrical storage component comprises a storage capacitor or a storage battery.

16. A battery case, comprising:
a base having first recess for receiving a first battery and a second recess for receiving a second battery;
a cover pivotally connected to the base and including a hinge lever proximate to the base;
a first battery carrier pivotally disposed on the base within the first recess and configured to receive and retain the first battery, and a second battery carrier pivotally disposed on the base within the second recess and configured to receive and retain the second battery; and
a linkage bar pivotally disposed in the base engaging at a first end with the hinge lever and engaging at a second end with the first battery carrier and the second battery carrier, wherein the engagement of the first end of the linkage bar with the hinge lever is configured in a manner that the hinge lever does not engage the first end of the linkage bar until the cover is approximately half-way open;
wherein the first battery carrier is configured to raise from the first recess and the second battery carrier is configured to raise from the second recess, simultaneously upon the engagement of the hinge lever with the first end of the linkage bar, pivoting of the linkage bar, and the engagement of the second end of the linkage bar with the first battery carrier and the second battery carrier.

17. The battery case of claim 16, wherein the linkage bar is biased to lower the first battery carrier into the first recess and the second battery carrier into the second recess when the cover is approximately half-way closed.

18. The battery case of claim 17, wherein the cover hinge is leveraged to maintain the cover fully open or fully closed.

19. The battery case of claim 16, further comprising a charging system disposed in the battery case and adapted to charge the first battery and the second battery, wherein the charging system comprises:
a first base electrical contact disposed in the first recess or on the first battery carrier and configured to electrically engage a battery electrical contact on the first battery;
a second base electrical contact disposed in the second recess or on the second battery carrier and configured to electrically engage a battery electrical contact on the second battery; and
an electrical storage component electrically connected to the first base electrical contact and the second base electrical contact.

20. The battery case of claim 19, further comprising an external electrical input electrically connected to the electrical storage component, wherein the electrical storage component comprises a storage capacitor or a storage battery.
